(19) United States
(12) Patent Application Publication
(10) Pub. No.: US 2025/0279696 A1
(43) Pub. Date: Sep. 4, 2025

(54) LINEAR GENERATOR SYSTEM HAVING A POLYGONAL LAYOUT

(71) Applicant: Mainspring Energy, Inc., Menlo Park, CA (US)

(72) Inventor: Matthew Svrcek, Redwood City, CA (US)

(21) Appl. No.: 19/067,605

(22) Filed: Feb. 28, 2025

Related U.S. Application Data
(60) Provisional application No. 63/560,353, filed on Mar. 1, 2024.

(51) Int. Cl. H02K 7/18; F02B 63/04; F02B 75/18

(52) U.S. Cl. CPC H02K 7/1884; F02B 63/041; F02B 75/18; F02B 2075/1856

(57) ABSTRACT

Generators are presented herein for generating power outputs using a plurality of linear electromagnetic machines (“LEMs”) affixed to a frame such that adjacent LEMs interact with a single power cylinder. The power cylinder includes a reaction volume, a first bore coaxial with a first axis, and a second bore coaxial with a second axis, different from the first axis, wherein the first axis and the second axis intersect in the reaction volume. The frame includes a plurality of members arranged in a polygon and a plurality of intermediate structures each comprising respective rigid extension, wherein each respective rigid extension is fixedly attached to respective axial ends of adjacent members of the plurality of members. Adjacent LEMs of a plurality of LEMs are coupled at each respective axial end of each respective LEM to the power cylinder using an intermediate structure of the plurality of intermediate structures.

### CROSS-REFERENCE TO RELATED APPLICATIONS

This application claims the benefit of U.S. Provisional Patent Application No. 63/560,353 filed Mar. 1, 2024, the disclosure of which is hereby incorporated by reference herein in its entirety.

### INTRODUCTION

The present disclosure is directed to a power cylinder for coupling multiple (e.g., concatenated, connected, or otherwise linked based on a shared power cylinder) linear electromagnetic machines (hereinafter “LEMs”) of a generator (e.g., a generator with components arranged in a polygonal shape so as to be considered a polygonal generator system) to be operated in a connected manner such that adjacent LEMs interface with a shared reaction volume within a power cylinder and the generator has a polygonal shaped with an even number of sides.

### SUMMARY

A power cylinder refers to a component of any suitable geometry that contains a reaction volume. It is understood that a power cylinder need not be cylindrical. For example, a power cylinder can include at least two intersecting bores. Additionally, or alternatively, the power cylinder can be comprised of disparate components that interface with each other or are affixed together to form a reaction volume. A system including multiple generators is described herein in order to increase power density and reduce components to assemble the system by incorporating power cylinders that have a shared reaction volume between adjacent generators. In general, any even number of power cylinder assemblies may be arranged in a pattern such that the arrangement may appear as a regular polygon (e.g., having sides of the same length, and interior angles that are all the same) or an irregular polygon (e.g., a polygonal arrangement of components with one or more of adjacent sides having varying angles therebetween or adjacent sides having varying lengths). Each generator described herein includes a LEM for converting kinetic energy of translators to electrical power based on movement of the translators relative to stationary stators (e.g., as would be affixed to a frame of the multiple generator systems described herein). In some embodiments, the system includes mounting six LEMs and six power cylinders in a hexagon pattern based at least in part on a target power output of the system and the configuration of a frame structured to support the system during operation. In this example embodiment, each LEM has a reaction volume on either axial end of each LEM which can, in some embodiments, eliminate the need to incorporate a structure including an air spring for rebounding a translator from a first apex to a second apex as the power cylinder on each axial end of each LEM provide a pressurized region already based on reactions in respective reaction volumes. In another embodiment, the system includes any even number of LEMs and power cylinders (e.g., 8 or more) without any air springs.

In some embodiments, the power cylinders of this disclosure each comprise a reaction volume, a first bore coaxial with a first axis, and a second bore coaxial with a second axis, different from the first axis, wherein the first axis and the second axis intersect in the reaction volume. In some embodiments, the first axis intersects with the second axis to form an angle (e.g., a small angle of intersection, or interior angle, less than 180°) directly proportional to N, wherein N is an even integer greater than or equal to 2.

In some embodiments, the power cylinder includes a feature configured to interface with a retaining element. For example, the retaining feature may be a retaining flange mated to a lip of the power cylinder. This retaining feature may be coupled or affixed to an intermediate or central portion of the power cylinder (e.g., by one or more of welding or fasteners).

In some embodiments, the power cylinder includes a first cylinder comprising the first bore, and a second cylinder comprising the second bore. An intermediate structure can be arranged between the first cylinder and the second cylinder. Additionally, or alternatively, the first cylinder forms a first seal on a first side of the intermediate structure, and the second cylinder forms a second seal on a second side of the intermediate structure. In some embodiments, the first cylinder and the second cylinder each interface with the intermediate structure by respective interference fits. In some embodiments, one or more of fasteners, welds, or weld seams are utilized to secure the first cylinder and the second cylinder to the intermediate structure. In some embodiments, the intermediate structure comprises a rigid extension.

In some embodiments, the power cylinders of this disclosure each comprise an intake port arranged towards a first axial end of the first bore, and an exhaust port arranged towards a second axial end of the second bore. Fuel and air provided to the intake port for reacting in the reaction volume propagates from the intake port to the exhaust port causing uniflow scavenging based on an arrangement of the intake port and the exhaust port at respective axial ends of respective bores of the power cylinder.

In some embodiments, this disclosure is directed to a generator frame comprising a plurality of members arranged in a polygon, a plurality of intermediate structures each comprising respective rigid extensions, wherein each respective rigid extension is fixedly attached to respective axial ends of adjacent members of the plurality of members. Affixed to the generator frame is a plurality of LEMs, wherein adjacent LEMs of the plurality of LEMs are coupled at each respective axial end of each respective adjacent LEM to a respective power cylinder of a plurality of power cylinders at a respective intermediate structure of the plurality of intermediate structures. Each respective power cylinder comprises a respective reaction volume, a respective first bore coaxial with a respective first axis, and a respective second bore coaxial with a respective second axis, different from the respective first axis, wherein the respective first axis and the respective second axis intersect in the reaction volume.

In some embodiments, the generator frames of this disclosure include a plurality of respective intermediate members that respectively affix a respective stator of a respective LEM of the plurality of LEMs to a respective member of the plurality of members. Additionally, or alternatively, the generator frames of this disclosure may include a plurality of stabilizing features, wherein each respective stabilizing feature of the plurality of stabilizing features is coupled to a respective LEM of the plurality of LEMs to minimize one or more of vibrations or movement of each LEM relative to the frame during operation of the plurality of LEMs.

In some embodiments, each member of the plurality of members comprises an I-beam geometry. Additionally, or alternatively, each member of the plurality of members comprises at least one through opening for one or more of weight reduction or accommodating one or more generator components.

In some embodiments, the disclosure is directed to a generator comprising a plurality of power cylinders and a plurality of LEMs arranged between adjacent pairs of the plurality of power cylinders. Each respective power cylinder of the plurality of power cylinder include a reaction volume, a first bore coaxial with a first axis, and a second bore coaxial with a second axis, different from the first axis, wherein the first axis and the second axis intersect in the reaction volume. In some embodiments, each LEM of the plurality of LEMs includes a respective stator affixed to a respective member of a plurality of members of a frame and a respective translator that electromagnetically interfaces with the respective stator to generate an electrical power output based on motion of the respective translator.

In some embodiments, the frame of the generator includes a plurality of members arranged in a polygon, and a plurality of intermediate structures each comprising respective rigid extension, wherein each respective rigid extension is fixedly attached to respective axial ends of adjacent members of the plurality of members.

In some embodiments, a respective first axis of a respective power cylinder of the plurality of power cylinders intersects with a respective second axis of the respective power cylinder to form an angle directly proportional to N, wherein N is an even integer greater than or equal to 2 (e.g., 6 or 8).

### BRIEF DESCRIPTIONS OF THE DRAWINGS

The above and other objects and advantages of the disclosure may be apparent upon consideration of the following detailed description, taken in conjunction with the accompanying drawings, in which:

FIG. 1 shows a generator with a plurality of power cylinders interfacing with adjacent pairs of LEM, in accordance with some embodiments of the disclosure;

FIG. 2 shows a power cylinder with a first bore and a second bore, in accordance with some embodiments of the disclosure;

FIG. 3 shows a piston for use with the power cylinder of FIG. 2, in accordance with some embodiments of the disclosure;

FIG. 4 shows a power cylinder with a pair of translators in cylinders that interface with a reaction volume of the power cylinder, in accordance with some embodiments of the disclosure;

FIG. 5 shows a stacked generator assembly, in accordance with some embodiments of this disclosure; and

FIG. 6 shows a generator with a number of LEMs directly proportional to a number of power cylinders, including a frame, in accordance with some embodiments of this disclosure.

The figures are not intended to be exhaustive or to limit the disclosure to the precise form disclosed. It should be understood that the concepts and embodiments disclosed can be practiced with modification and alteration, and that the disclosure is limited only by the claims and the equivalents thereof.

### DETAILED DESCRIPTION

The present disclosure provides a power cylinder for coupling multiple LEMs of a generator to be operated in a connected manner such that adjacent LEMs interface with a shared reaction volume within a power cylinder and the generator has a polygonal shaped with an even number of sides.

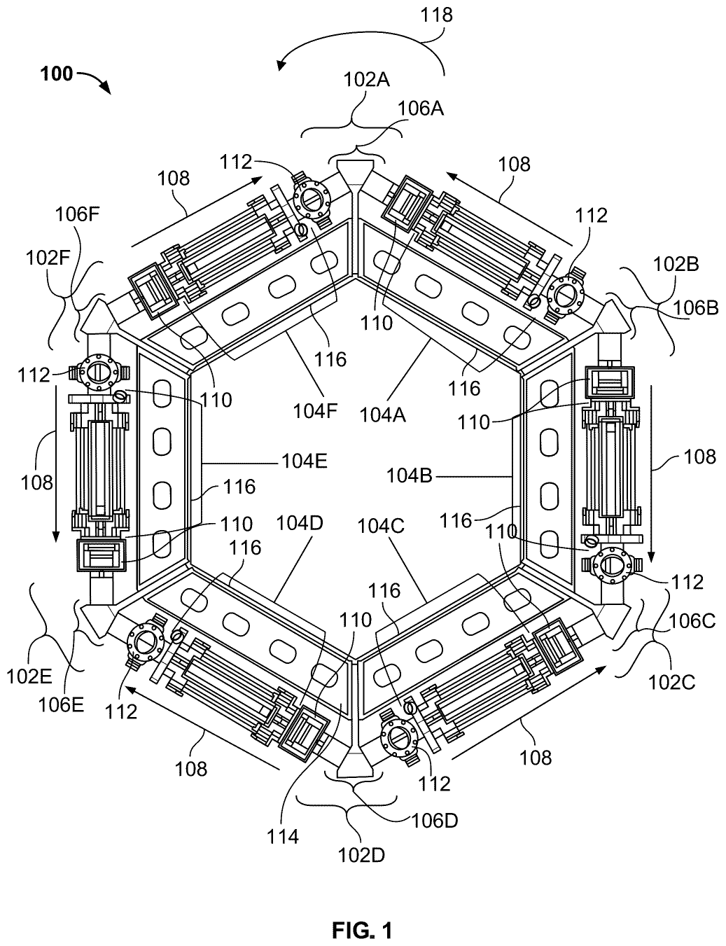

FIG. 1 shows generator 100 with power cylinders 102A-102F interfacing with adjacent pairs of LEMs 104A-104F, in accordance with some embodiments of the disclosure. As shown in FIG. 1, generator 100 includes reaction volumes 106A-106F, corresponding to six reaction volumes, that are shared by, or interfacing with, adjacent pairs of LEMs 104A-104F. The reaction volumes are understood to not be directly limited by the brackets used to label the reaction volumes in FIG. 1. Any suitable geometry or location of a reaction volume may be incorporated into generator 100. In some embodiments, one or more of the shown reaction volumes may comprise one or more different measurements, shapes, or sizes based on target operational characteristics for reach respective power cylinder (e.g., based at least in part on target power output or exhaust content requirements). Accordingly, generator 100 can be considered to have a polygon shape such as a hexagon. Generator 100 can, in some embodiments, be constructed with any even integer number of sides and vertices (e.g., “N”) that is greater than 2 (e.g., including 8, thereby forming a polygon shaped considered an octagon). The N number of sides is directly proportional to the number of LEMs, and the number of power cylinders arranged between the adjacent LEMs. In some embodiments, reaction volumes 106A-106F, each arranged at a vertex of the polygon, are configured to be operated according to phase offset cycles (e.g., complementary reaction timings in each of reaction volumes 106A-106F such that net forces are offset or minimized) and the phase offset cycles cause LEMs 104A-104F to operate in two groups. A cycle as used in this disclosure corresponds to a translator of this disclosure actuating within a cylinder from a top dead center (hereinafter “TDC”) position to a bottom dead center (hereinafter “BDC”) position and back to a TDC position. As the translator approaches TDC, the cycle includes causing a reaction to occur between a pair of opposed translators (e.g., by compression ignition). In some embodiments, a previous cycle is any cycle that occurred before a current cycle. A subsequent cycle is considered any cycle that occurs after a current cycle.

As used herein, a translator corresponds to an assembly that uses a piston rod to couple a piston (e.g., where the piston face is in contact with a reaction volume) to an opposing component (e.g., a second piston) that provides a return force responsive to a reaction in the reaction volume. In some embodiments, the pistons may have a contoured piston face in order to achieve one or more of ideal reaction conditions in each respective reaction volume or to achieve a target apex (e.g., TDC or BDC). A translator electromagnetically interacts with a stator with a plurality of windings to convert mechanical energy of the translator to an electrical output. Each translator as described herein comprises at least a translator tube that connects to opposing pistons. The translator tube comprises any suitable beam shape, or geometry for connecting the opposing pistons (e.g., such as a rod or cylinder). Each translator of the plurality of LEMs comprises a respective number of magnets and each respective translator translates along the longitudinal axis within a respective cylinder.

Based on the arrangement of components of generator 100 as shown in FIG. 1, reactions in reaction volumes 106A, 106C, and 106E may be configured to operate according to a cycle such that the reactions in each of reaction volumes 106A, 106C, and 106E are to occur as respective translators of adjacent LEMs achieve a first apex within a respective cylinder of power cylinders 102A, 102C, and 102E, respectively. Where these operating conditions are achieved, reactions in reaction volumes 106B, 106D, and 106F may be configured to operate according to a cycle such that the reactions in each of reaction volumes 106B, 106D, and 106F are to occur as respective translators of adject LEMs achieve a second apex opposite the first apex (e.g., where the first apex is TDC, the second apex is BDC, or vice versa).

Arrows 108 illustrate the projected trajectories of respective translators of LEMs 104A-104F as achieving different apexes according to the following described operational cycle. LEMs 104A and 104F can be operated such that first ends of their respective translators achieve TDC in power cylinder 102A while first ends of respective translators of LEMS 104B and 104C achieve TDC in power cylinder 102C. Additionally, LEMs 104D and 104E can also be operated such that first ends of their respective translators achieve TDC in power cylinder 102E in a manner synchronized with TDC being achieved in each of power cylinder 102A and power cylinder 102C. When achieving TDC, the first ends of translators interfacing with power cylinders 102A, 102C and 102E can be considered to be completing a compression stroke of an operational cycle of generator 100. LEMs 104A and 104B can be operated such that second ends of their respective translators achieve BDC in power cylinder 102B while the respective second ends of translators of LEMS 104C and 104D achieve BDC in power cylinder 102D. Additionally, LEMs 104E and 104F can also be operated to such that respective second ends of their respective translators achieve BDC in power cylinder 102F in a manner synchronized with BDC being achieved in each of power cylinder 102B and power cylinder 102D. When achieving BDC, the second ends of translators interfacing with power cylinders 102B, 102D and 102F can be considered to be completing an expansion stroke of an operational cycle of generator 100. Each translator is configured to interface to two of the six reaction volumes during an operation cycle of generator 100, and wherein the respective cycle in the two reaction volumes may be phased up to 180° apart.

Generator 100 also includes intake ports 110 and exhaust ports 112, where each of LEMs 104A-104F receive air and fuel for reacting in the reaction volumes of generator 100 by at least one of intake ports 110 while expelling exhaust materials from reactions within the reaction volumes through at least one of exhaust ports 112. In some embodiments, each of intake ports 110 may be at least partially enclosed, or housed by, an air plenum (e.g., a box or volume of suitable geometry for receiving one or more of air from an air supply or fuel from a fuel reservoir). Each of exhaust ports 112 may interface with, or include, a respective manifold that is tuned and sized based on sizing of each of exhaust ports 112 and target operational characteristics of generator 100 (e.g., exhaust content, noise output, or power output). As exemplified by the arrangement of components of generator 100, the generators of this disclosure can be configured for uniflow scavenging such that intake content (e.g., some combination of air and fuel) and exhaust gases flow in a same direction along each side of generator 100 based at least in part on the arrangement of intake ports 110 on a first axial side of the LEMs of generator 100 that is opposite a second axial side of the LEMs, where exhaust ports 112 are arranged.

Arrow 118 depicts a direction of uniflow scavenging through a portion of generator 100 from one of intake ports 110 to one of exhaust ports 112 based at least in part on a reaction that occurred at least partially in a reaction volume of power cylinder 102A between LEMs 104A and 104F. An air-fuel mixture is provided through intake port 110 proximate to LEM 104A, which is then reacted in power cylinder 102A and expelled through exhaust port 112 proximate to LEM 104F. The orientation and direction of arrow 118 (e.g., corresponding to a direction and path of intake and exhaust elements that can be characterized as uniflow scavenging) can be applied to each of power cylinders 102A-102F based on respective arrangements of intake ports 110 and exhaust ports 112 relative to each respective power cylinder shown in generator 100 of FIG. 1.

Generator 100 is supported by frame 114, which is comprised of members 116 arranged in a polygon (e.g., a hexagon as shown in FIG. 1, or any suitable polygon based on an even integer number of sides greater than 2). LEMs 104A-104F are not expected to experience appreciable side loads, which are loads from a radially inner portion of generator 100 that propagate radially outwards towards an outer perimeter of generator 100 as translators of LEMs 104A-104F each move along a straight bore (e.g., a bore of a cylinder that interfaces with one of power cylinders 102A-102F) with uniform gas pressure all the way up to a sealing ring of a translator (e.g., which creates a gas tight sealing against a bore of one of the aforementioned cylinders during operation of generator 100). This gas pressure is expected to be substantially perpendicular to each bore of generator 100, thereby expected to create a net side load that is unappreciable from a perspective of each LEM. Each of member 116 may be any suitable size, shape, and material for supporting components of generator 100 for an expected operational lifetime of generator 100. For example, each of members 116 may comprise one or more of an I-beam shape, a box cross section, or a frame that may be formed out of steel (e.g., a low carbon steel). Plates (not shown in FIG. 1) may be welded to axial ends of members 116 for affixing components of power cylinders 102A-102F between adjacent members of members 116.

Generator 100 is considered to provide improvements over certain linear generator assemblies. For example, generator 100 as shown has a reaction force affecting translators at the end of each stroke. Stroke lengths of generator 100 may also be different from certain linear generator assemblies and pressure profiles relative to positioning of the oscillating components may be scaled linearly with each stroke.

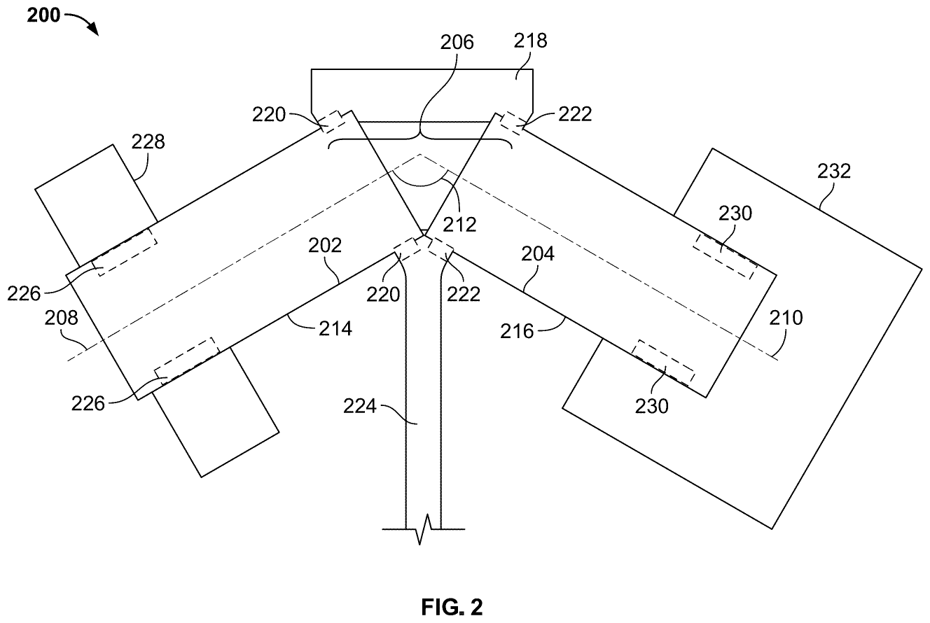

FIG. 2 shows power cylinder 200 with first bore 202 and second bore 204, in accordance with some embodiments of the disclosure. Power cylinder 200 corresponds to any of power cylinders 102A-102F of FIG. 1. First bore 202 is coaxial to first axis 208. Second bore 204 is coaxial to second axis 210. Second axis 210 extends along an orientation angled (e.g., at an angle proportional to N, representing one or more of a number of sides of a generator such as generator 100 of FIG. 1 or a number of LEMs) relative to first axis 208 and is different from first axis 208. First axis 208 intersects with second axis 210 in reaction volume 206 (e.g., where reaction volume 206 includes or is part of a reaction section for reacting an air-fuel mixture for translating translators relative to a stator in order for a generator to produce an electrical power output based on an electromagnetic interaction between the moving translator and stationary stator). In some embodiments, depending on operating conditions, the reaction section (e.g., a region where a reaction occurs to cause displacement of a translator within a cylinder) may extend at least partially into each of first bore 202 and second bore 204. Where first axis 208 intersects with second axis 210 is angle 212. Angle 212 is directly proportional to N, as described in reference to FIG. 1. For example, where power cylinder 200 is used with in a generator with six LEMs (e.g., generator 100), angle 212 is 120 degrees as represented by Formula (1) below:

$$Degrees of Angle 212 = \frac{( N - 2 ) \times 180}{N} \qquad Formula ( 1 )$$

Power cylinder 200 also includes first cylinder 214 and second cylinder 216. First cylinder 214 includes first bore 202. Second cylinder 216 includes second bore 204. Encompassing, or housing, reaction volume 206 is intermediate structure 218 which is arranged between first cylinder 214 and second cylinder 216. First cylinder 214 forms first seal 220 on a first side of intermediate structure 218. Second cylinder 216 forms second seal 222 on a second side of intermediate structure 218. In some embodiments, first cylinder 214 and second cylinder 216 each interface with intermediate structure 218 by respective interference fits. An interference fit as used herein is a type of mechanical fastening where two components interface by deforming such that the two components are held together by friction such that a tight fit is created between the two components. Any suitable mechanical affixing method may be utilized between the cylinders and intermediate structure 218 so long as the mechanical affixing does not affect the integrity of either of first seal 220 or second seal 222 for one or more of a designated service interval defined by operation of power cylinder 200 or an operational lifetime of a generator (e.g., generator 100 of FIG. 1). First seal 220 and second seal 222 are configured for preventing leaking of gaseous materials into or out of reaction volume 206. Power cylinder 200 may include multiple joined components such as first cylinder 214, second cylinder 216 and the curved cylinder section around the reaction volume 206. These components may be made from machining or casting or a combination thereof and it may be welded or bolted together or joined with the aforementioned interference fit, or any combination of joining methods. The cylinders 214 and 216 may be made of a cast or machined metal or a casting that has a metal sleeve in the inner diameter.

Extending away from reaction volume 206 is rigid extension 224. Rigid extension 224 is part of intermediate structure 218. Rigid extension 224 can be arranged between adjacent members of a frame of a generator (e.g., members 116 of frame 114 of generator 100 as shown in FIG. 1). Rigid extension 224 is structure to provide support to reaction volume 206 for an operational lifetime of a generator (e.g., generator 100). Based on which portions of a generator frame are directly coupled to rigid extension 224, rigid extension 224 can provide a load path for side loads generated based on a reaction in reaction volume 206 such that the side loads are transferred to adjacent members of the aforementioned frame. In some embodiments, a retaining element (not shown) of intermediate structure 218 is configured to receive, or interface with, the axial ends, or lips extending from the axial ends, of cylinders 214 and 216. The axial ends, or lips extending from the axial ends, may be considered a feature or a retaining element. This feature is configured to interface with the retaining feature, or retaining element, by a mechanical affixing method such as using one or more fasteners or weld seams. The retaining feature may, for example, comprise a retaining flange for receiving the axial ends of cylinders 214 and 216 so as to maintain the integrity of first seal 220 and second seal 222.

First cylinder 214 includes exhaust ports 226 arranged towards an axial end of first bore 202. Exhaust ports 226 enable propagation of exhaust products from a reaction of air and fuel in reaction volume 206 towards exhaust manifold 228. Exhaust manifold 228 may be mounted in any suitable manner. For example, as the cylinders of FIG. 2 are secured to intermediate structure 218, first cylinder 214 may be used to rigidly attach exhaust manifold 228. In some embodiments, exhaust manifold 228 may not be rigidly attached and are permitted to have certain compliance in terms of relative movement relative to first cylinder 214 (e.g., where exhaust manifold 228 is considered to float on cylinder 214 to allow for thermal expansion) and may instead to rigidly attached to a frame of a generator comprising power cylinder 200. Second cylinder 216 includes intake ports 230 arranged towards an axial end of second bore 204. Intake ports 230 enable reception of an air-fuel mixture, at least in part from intake plenum 232, so as to enable translators of LEMs to compress the air-fuel mixture and cause a reaction in reaction volume 206. Intake plenum 232 may be coupled to second cylinder 216 in any suitable manner, including the manner described for exhaust manifold 228. Fuel and air provided to intake ports 230 for reacting in, or proximate to (e.g., extending at least partially into the adjacent cylinders), reaction volume 206 propagates from intake ports 230 to exhaust ports 226 causing uniflow scavenging based on the arrangement of these ports at respective axial ends of respective bores of power cylinder 200.

As shown in FIG. 2, a volume defined at least in part by angled axial ends of first cylinder 214 and second cylinder 216 forms a volume larger than necessary for target compression ratios within power cylinder 200. For example, the volume considered excess in terms of the target compression ratios can be a volume of space (e.g., a dead volume) within power cylinder 200 that is never occupied by a respective end (e.g., a piston) of one or more translators within first cylinder 214 or second cylinder 216 during operation of power cylinder 200. In some embodiments, pistons at ends of respective translators that move along bores of first cylinder 214 and second cylinder 216. These respective pistons may include protrusions that extend from each of their respective faces to fill this excess volume. As a result, the volume of air-fuel mixture for reacting within reaction volume 206 (e.g., as caused by compression based on positioning of the aforementioned pistons) is optimized, or minimized, to be within a target or desired range of volumes within reaction volume 206 as translator ends approach TDC in reaction volume 206 based on target operational output conditions (e.g., one or more of power output or exhaust content). In some embodiments, these protrusions that extend from the piston face may be shaped in such a way that respective heat transfer surface areas of each piston face is minimized while occupying enough of reaction volume 206 to achieve the aforementioned desired operational output conditions.

In some embodiments, intermediate structure 218 is of a geometry to facilitate uniflow scavenging from intake ports to exhaust ports. For example, a radially outboard wall (e.g., corresponding to the wider portion of reaction volume 206) of intermediate structure 218 may be curved to enable air-fuel mixtures and reacted air-fuel mixtures to flow through intermediate structure 218 and propagate towards a corresponding exhaust port in a manner that reduces turbulence of flow or improves expulsion of exhaust (e.g., products of a reaction of the air-fuel mixture within reaction volume 206). In some embodiments, a radially inboard wall (e.g., corresponding to the narrower portion of reaction volume 206) of intermediate structure may also be, or may alternatively be, curved in a manner described in reference to the radially outboard wall.

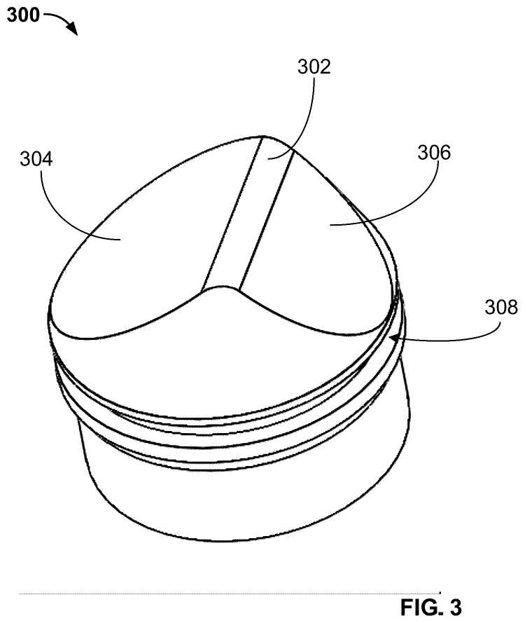

FIG. 3 shows piston 300 for use with power cylinder 200 of FIG. 2, in accordance with some embodiments of the disclosure. As described in reference to FIG. 2, a dead volume may be present in reaction volumes of power cylinders of this disclosure. Piston 300 includes protrusion 302 formed between angled piston face 304 and angled piston face 306. Protrusion 302 reduces, or optimizes, a potential dead volume within reaction volume 206 of FIG. 2. Piston 300 also includes sealing ring groove 308, which is for accommodating a sealing ring that seals against bores of cylinders of this disclosure (e.g., when expanded radially outward to contact bores of cylinders of this disclosure).

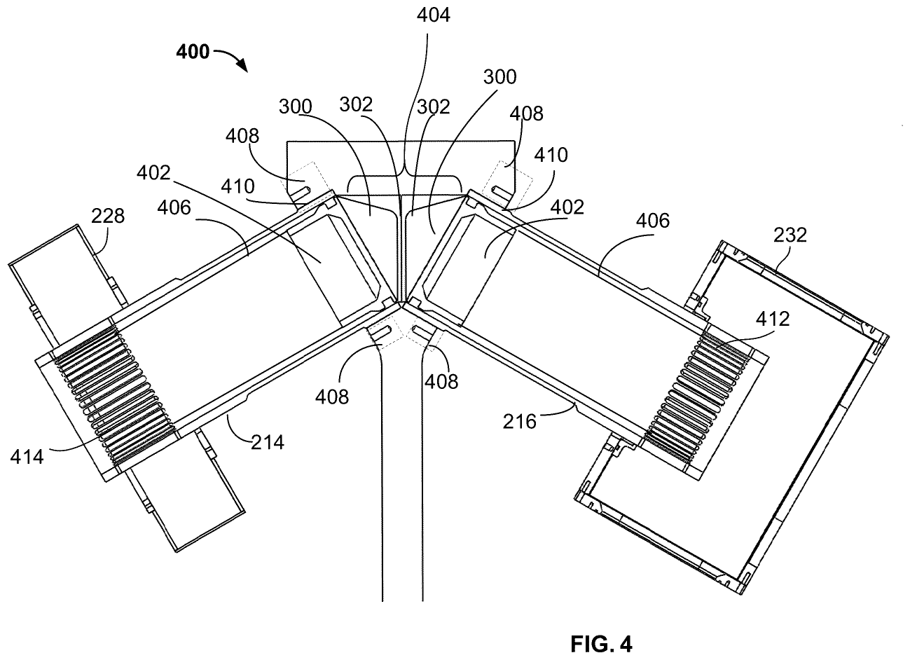

FIG. 4 shows a cross sectional view of power cylinder 400 with a pair of translators 402 in cylinders that interface with reaction volume 404, in accordance with some embodiments of the disclosure. Power cylinder 400 may include any or all components shown in, or described in reference to, power cylinder 200 of FIG. 2. Translators 402 each comprise piston 300 of FIG. 3, including respective protrusions 302. Extending away from pistons 300 are translator tubes 406 which extend along first cylinder 214 and second cylinder 216. As shown in FIG. 4, flanges 408 extend over the outer surface of first cylinder 214 and second cylinder 216. Flanges 408 interface with steps 410 to create contact with walls of each of first cylinder 214 and second cylinder 216. Flanges 408 each get one or more of an interference fit, bolted, or welded to the outer walls, or outer surfaces, of first cylinder 214 and second cylinder 216. A seal, such as a gasket or o-ring (e.g., which may correspond to a flange seal) may surround each of first cylinder 214 or second cylinder 216 or reside on the faces of any interface flanges on the cylinders 214 and 216; the seal is compressed to form respective seals (e.g., first seal 220 and second seal 222 of FIG. 2). In some embodiments, the welds or bolts are arranged in a substantially circular pattern around the ends of first cylinder 214 and second cylinder 216 such that there is relatively even distribution of a clamping force caused by one or more of the welds or the bolts.

Second cylinder 216 includes intake ports 412 (e.g., corresponding to intake ports 230 of FIG. 2) arranged towards an axial end of second cylinder. Intake ports 412 enable reception of an air-fuel mixture, at least in part from intake plenum 232, so as to enable translators of LEMs to compress the air-fuel mixture and cause a reaction in reaction volume 206. Intake plenum 232 may be coupled to second cylinder 216 in any suitable manner, including the manner described for exhaust manifold 228. Fuel and air provided to intake ports 412 for reacting in, or proximate to (e.g., extending at least partially into the adjacent cylinders), reaction volume 404 propagates from intake ports 412 to exhaust ports 414 (e.g., corresponding to exhaust ports 226 of FIG. 2) causing uniflow scavenging based on the arrangement of these ports at respective axial ends of respective bores of power cylinder 400.

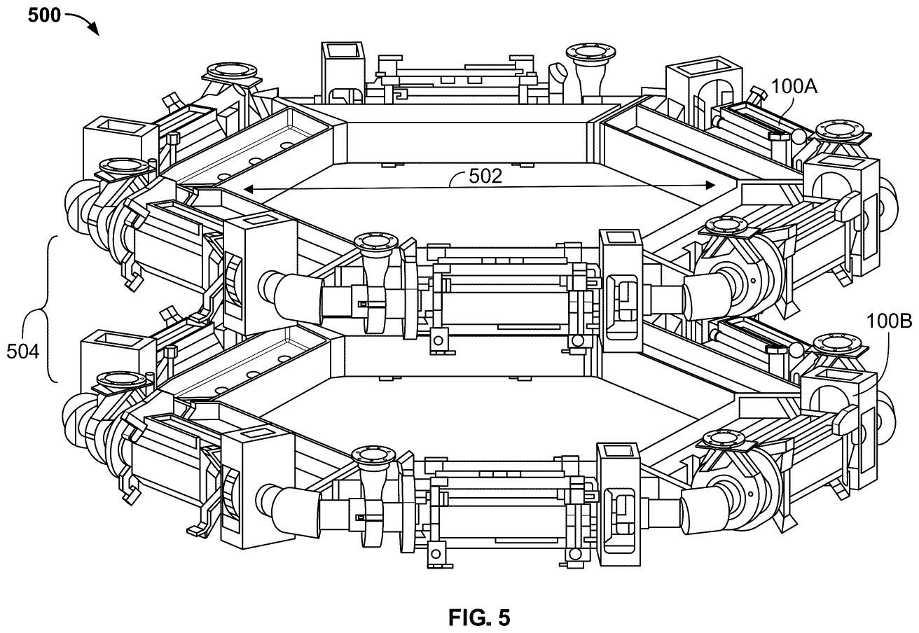

FIG. 5 shows stacked generator assembly 500, in accordance with some embodiments of this disclosure. Generator assembly 500 depicts generator 100A arranged over generator 100B. Each of generators 100A and 100B correspond to generator 100 of FIG. 1. Two or more generators may be stacked in such an arrangement. A frame, attached to or distinct from members coupling LEMs but not shown in FIG. 5, may be used to support each generator assembly 500. The frame may have access locations with openings or removable regions to service aspects of the generator assembly 500 such as for replacing sealing rings and servicing various components. A benefit of stacked generator assembly 500 is annulus 502. Annulus 502 can be utilized to arrange components of stacked generator assembly 500 that do not require regular maintenance intervals (e.g., one or more of exhaust components, acoustic ducts and corresponding baffles, tuned pipes, or fans). Access region 504 corresponds to a potential arrangement of an access hat for servicing various components of stacked generator assembly 500. Some components that may require servicing over an operational lifetime of stacked generator assembly 500 include one or more of grid-tie inverters, power and control management circuitry, battery components or cases, filters, fuel train components, or air compressors for providing pressurized air to air bearings that support translators of the LEMs of this disclosure as they translate along cylinders of this disclosure. In some embodiments, a single air compressor may be arranged to compress air for each LEM of stacked generator assembly 500 (or any generator of this disclosure). In some embodiments, a single air compressor may be arranged to compress air for all LEMs of stacked generator assembly 500 (or any generator of this disclosure).

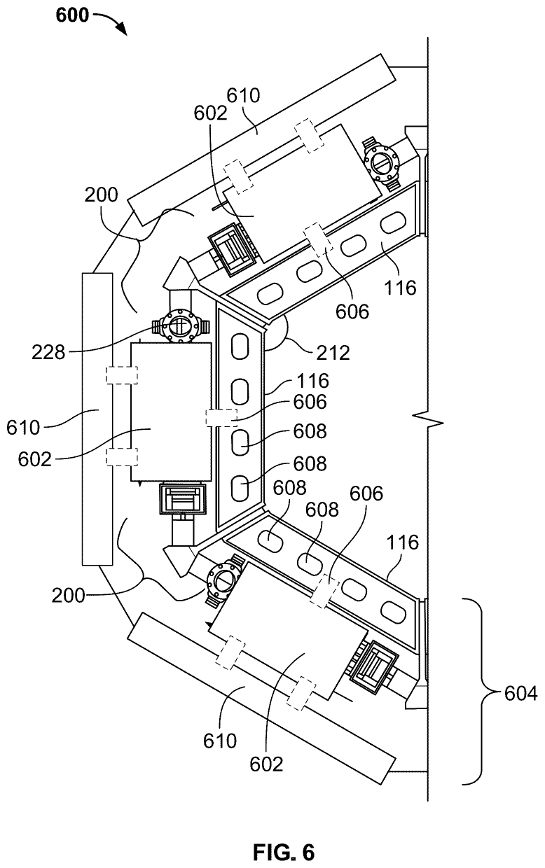

FIG. 6 shows generator 600 with a number of LEMs 602 directly proportional to a number of power cylinders 200, and including frame 604 that surrounds the arrangement of LEMs and power cylinders shown in FIG. 6, in accordance with some embodiments of this disclosure. Although only two of power cylinders 200 are labelled, generator 600 is partially cut off based on angle 212 of FIG. 2, such that any even number of LEMs 602 and power cylinders 200 are assumed to be added to generator 600 to retain the same number of LEMs 602 and power cylinders 200 (e.g., such that generator 600 includes an even integer number of LEMs 602 that equals an even integer number of power cylinders 200 that is greater than 2). Each of LEMs 602 corresponds to any or all of LEMs 104A-104F, including respective stationary stators and respective translators that move relative to a respective stationary stator. Between adjacent pairs of LEMs 602 are power cylinders 200 of FIG. 2. Power cylinders 200 may include any or all components described in reference to any or all power cylinders of this disclosure. As shown in FIG. 6, each of LEMs 602 is fixedly attached to a respective member 116 of frame 604 by a respective one of intermediate members 606. Intermediate members 606 at least partially restrict movement of the stators of LEMs 602 relative to respective members 116 of frame 604. Any suitable means for fixedly attaching a stator to a frame may be utilized to create one or more of intermediate members 606. Intermediate members 606 do not overlap with openings 608 (e.g., through openings), which are configured to reduce weight of members 116 and, in some embodiments, can be configured to accommodate one or more auxiliary components of generator 600. Arranged around an outer perimeter of LEMs 602 are stabilizing features 610 which are structured to maintain structural integrity of the overall assembly while compensating for vibration sourced forces or relative movements of LEMs 602 from affecting structural integrity of frame 604 or overall generator 600 (e.g., including bulk movements of one or more components of an overall assembly or oscillatory movement that propagates between components). Stabilizing features 610 may be stand-alone, or at least partially isolated, components only coupled to LEMs 602 or may be anchored to a surface, such as a campus floor where generator 600 is installed to generate power.

It is noted that any multi-part reference numerals may be collectively referenced by the shared reference numeral. It is further noted that certain elements may appear multiple times within a single figure. For clarity of illustration, each instance of such elements may not be explicitly labeled with a reference numeral. As will be understood by one of ordinary skill in the art, such unlabeled instances are not necessarily different from the corresponding labeled instances due to lacking a reference numeral. Additionally, they are also not necessarily the same.

It will be understood that the present disclosure is not limited to the embodiments described herein and can be implemented in the context of any suitable system. In some suitable embodiments, the present disclosure is applicable to reciprocating generators and compressors. In some embodiments, the present disclosure is applicable to generators and compressors. In some embodiments, the present disclosure is applicable to reaction devices such as a reciprocating generator and a generator. A reaction device is inclusive of reaction related devices. A reaction, as used herein, is inclusive of both non-combustion reactions and combustion reactions. In some embodiments, the present disclosure is applicable to non-combustion and non-reaction devices such as reciprocating compressors and compressors. In some embodiments, the present disclosure is applicable to oil-free reciprocating generators and compressors. In some embodiments, the present disclosure is applicable to oil-free generators with internal or external reactions. In some embodiments, the present disclosure is applicable to oil-free generators that operate with compression ignition (e.g., homogeneous charge compression ignition, stratified charge compression ignition, or other compression ignition), spark ignition, or both. In some embodiments, the present disclosure is applicable to oil-free generators that operate with gaseous fuels, liquid fuels, or both.

As used herein, the term “fuel” refers to matter that reacts (e.g., with an oxidizer). Suitable fuels for use with any or all of the systems, assemblies, or components of this disclosure include common gaseous alkanes or alkenes (e.g., methane, ethane, propane, ethylene, propene), alcohols (methanol, ethanol, propanol), hydrocarbon fuels (e.g., one or more of natural gas, biogas, gasoline, diesel, biodiesel, propane, or ethane), non-hydrocarbon fuels (e.g., one or more of hydrogen or ammonia), alcohol fuels (e.g., one or more of ethanol, methanol, or butanol) or any mixtures of any of the aforementioned fuels. The generators described herein are suitable for both stationary power generation and portable power generation (e.g., for one or more of power grid powering or vehicle propulsion such as a vehicle for on land over or over a marine environment with water, including hybrid vehicles that utilize power from multiple or at least two power sources of different power generating capabilities, or vehicle on-board power generation such as for battery charging). In some embodiments, the present disclosure is applicable to linear generators. In some embodiments, the present disclosure is applicable to generators that can be reaction generators with internal reaction or any type of heat generator with external heat addition (e.g., from a heat source or external reaction such as combustion). In some embodiments, the present disclosure is applicable to closed cycle linear generators having a burner for reacting a fuel to generate heat for the closed cycle linear generator (e.g., closed cycle free-piston heat engine). Additionally, or alternatively, a closed cycle free piston linear generator or a closed cycle free piston heat engine can be considered suitable architecture for integrating into or incorporating any or all of the systems, assemblies, or subcomponents thereof of this disclosure.

The foregoing is merely illustrative of the principles of this disclosure and various modifications may be made by those skilled in the art without departing from the scope of this disclosure. The above described embodiments are presented for purposes of illustration and not of limitation. The present disclosure also can take many forms other than those explicitly described herein. Accordingly, it is emphasized that this disclosure is not limited to the explicitly disclosed methods, systems, and apparatuses, but is intended to include variations to and modifications thereof, which are within the spirit of the following claims.

What is claimed is:

1. A power cylinder comprising:
a reaction volume;
a first bore coaxial with a first axis; and
a second bore coaxial with a second axis, different from the first axis, wherein the first axis and the second axis intersect in the reaction volume.

2. The power cylinder of claim 1, further comprising a feature configured to interface with a retaining element.

3. The power cylinder of claim 1, wherein the first axis intersects with the second axis to form an angle directly proportional to N, wherein N is an even integer greater than or equal to 2.

4. The power cylinder of claim 1, further comprising:
a first cylinder comprising the first bore; and
a second cylinder comprising the second bore.

5. The power cylinder of claim 4, further comprising an intermediate structure between the first cylinder and the second cylinder.

6. The power cylinder of claim 5, wherein:
the first cylinder forms a first seal on a first side of the intermediate structure; and
the second cylinder forms a second seal on a second side of the intermediate structure.

7. The power cylinder of claim 5, wherein the first cylinder and the second cylinder each interface with the intermediate structure by respective interference fits.

8. The power cylinder of claim 5, wherein the first cylinder and the second cylinder each interface with the intermediate structure by respective welds or respective weld seams.

9. The power cylinder of claim 5, wherein the first cylinder and the second cylinder are each affixed to respective ends of the intermediate structure by one or more fasteners.

10. The power cylinder of claim 5, wherein the first axis and the second axis define a region corresponding to a small angle of intersection less than 180 degrees, and wherein the intermediate structure comprises a rigid extension extending into the region.

11. The power cylinder of claim 1, further comprising:
an intake port arranged towards a first axial end of the first bore; and
an exhaust port arranged towards a second axial end of the second bore.

12. The power cylinder of claim 11, wherein fuel and air provided to the intake port for reacting in the reaction volume propagate from the intake port to the exhaust port causing uniflow scavenging.

13. A generator frame comprising:
a plurality of members each arranged along a respective side of a polygon, wherein each respective pair of adjacent members interface at a respective vertex of the polygon; and
a plurality of intermediate structures each comprising a respective rigid extension, wherein each respective rigid extension extends from the respective vertex, wherein each rigid extension couples to a respective power cylinder of a plurality of power cylinders, each respective power cylinder comprising:
a respective reaction volume,
a respective first bore coaxial with a respective first axis, and
a respective second bore coaxial with a respective second axis, different from the respective first axis, wherein the respective first axis and the respective second axis intersect in the reaction volume.

14. The generator frame of claim 13, wherein each member is configured to be coupled to a respective linear electromagnetic machine (LEM) of a plurality of LEMs, each respective LEM comprising:
a respective stator affixed to a respective member of the plurality of members; and
a respective translator that electromagnetically interfaces with the respective stator to generate an electrical power output based on motion of the respective translator.

15. The generator frame of claim 14, further comprising a plurality of respective intermediate members configured to affix the respective stator to the respective member.

16. The generator frame of claim 13, further comprising a plurality of stabilizing features, wherein each respective stabilizing feature of the plurality of stabilizing features is coupled to a respective linear electromagnetic machine (LEM) of a plurality of LEMs to minimize movement of each LEM relative to the generator frame during operation of the plurality of LEMs.

17. The generator frame of claim 13, wherein each respective power cylinder further comprises:
a respective first cylinder comprising the respective first bore; and
a respective second comprising the respective second bore.

18. The generator frame of claim 17, wherein:
the respective first cylinder forms a respective first seal on a respective first side of a respective intermediate structure of the plurality of intermediate structures; and
the respective second cylinder forms a respective second seal on a second side of the respective intermediate structure.

19. The generator frame of claim 18, wherein the respective first cylinder and the respective second cylinder each interface with the respective intermediate structure by respective interference fits.

20. The generator frame of claim 18, wherein the respective first cylinder and the respective second cylinder each interface with the intermediate structure by respective welds or respective weld seams.

21. The generator frame of claim 18, wherein the respective first cylinder and the respective second cylinder are each affixed to respective ends of the intermediate structure by one or more fasteners.

22. The generator frame of claim 13, wherein a respective first axis of a respective power cylinder of the plurality of power cylinders intersects with a respective second axis of the respective power cylinder to form an angle directly proportional to N, wherein N is an even integer greater than or equal to 2.

23. The generator frame of claim 13, wherein each member of the plurality of members comprises an I-beam geometry.

24. The generator frame of claim 13, wherein each member of the plurality of members comprises at least one through opening to cause one or more of weight reduction or accommodation of one or more generator components.

25. A generator comprising:
a plurality of power cylinders, each respective power cylinder of the plurality of power cylinder comprising:
a reaction volume,
a first bore coaxial with a first axis, and
a second bore coaxial with a second axis, different from the first axis, wherein the first axis and the second axis intersect in the reaction volume; and
a plurality of linear electromagnetic machines (“LEMs”) arranged between adjacent pairs of the plurality of power cylinders.

26. The generator of claim 25, wherein each LEM of the plurality of LEMs comprises:
a respective stator affixed to a respective member of a plurality of members of a frame; and
a respective translator that electromagnetically interfaces with the respective stator to generate an electrical power output based on motion of the respective translator.

27. The generator of claim 25, further comprising a frame, the frame comprising:
a plurality of members each arranged along a respective side of a polygon; and
a plurality of intermediate structures each comprising a respective rigid extension, wherein each respective rigid extension is fixedly attached to respective axial ends of adjacent members of the plurality of members.

28. The generator of claim 27, further comprising a plurality of intermediate members, wherein each respective intermediate member affixes a respective stator of a respective LEM of the plurality of LEMs to a respective member of the plurality of members.

29. The generator of claim 27, wherein each LEM of the plurality of LEMs comprises:
a respective stator affixed to a respective member of the plurality of members; and
a respective translator that electromagnetically interfaces with the respective stator to generate an electrical power output based on motion of the respective translator.

30. The generator of claim 27, further comprising a plurality of stabilizing features, wherein each respective stabilizing feature of the plurality of stabilizing features is coupled to a respective LEM of the plurality of LEMs to minimize one or more of vibrations or movement of each LEM relative to the frame during operation of the plurality of LEMs.

31. The generator of claim 25, wherein each respective power cylinder further comprises:
a respective first cylinder comprising the respective first bore; and
a respective second comprising the respective second bore.

32. The generator of claim 31, wherein:
the respective first cylinder forms a respective first seal on a respective first side of a respective intermediate structure of the plurality of intermediate structures; and
the respective second cylinder forms a respective second seal on a second side of the respective intermediate structure.

33. The generator of claim 32, wherein the respective first cylinder and the respective second cylinder each interface with the respective intermediate structure by respective interference fits.

34. The generator of claim 32, wherein the respective first cylinder and the respective second cylinder each interface with the intermediate structure by respective welds or respective weld seams.

35. The generator of claim 32, wherein the respective first cylinder and the respective second cylinder are each affixed to respective ends of the intermediate structure by one or more fasteners.

36. The generator of claim 25, wherein a respective first axis of a respective power cylinder of the plurality of power cylinders intersects with a respective second axis of the respective power cylinder to form an angle directly proportional to N, wherein N is an even integer greater than or equal to 2.
